(19) United States
(12) Patent Application Publication
(10) Pub. No.: US 2026/0347168 A1
(43) Pub. Date: Nov. 5, 2026

(54) SYSTEM AND METHOD FOR AUTOMATED DOSING OF STOCK SOLUTION

(71) Applicant: URBANKISAAN FARMS PVT LTD., Hyderabad (IN)

(72) Inventors: Sairam Palicherla Reddy, Hyderabad (IN); Vs Vihari Kanukollu,, Hyderabad (IN); Yarrabothu Kishore Kumar, Hyderabad (IN); Ramakrushnannaidu Kishore Runku, Hyderabad (IN); Mahendrawada Phanindra Sarma., Hyderabad (IN)

(73) Assignee: URBANKISAAN FARMS PVT LTD., Hyderabad (IN)

(21) Appl. No.: 19/055,078

(22) Filed: Feb. 17, 2025

(30) Foreign Application Priority Data
Aug. 15, 2022 (IN) 202241046306

(51) Int. Cl. B67D 3/00; G05B 23/02

(52) U.S. Cl. CPC B67D 3/0077; B67D 3/0003; G05B 23/0283; G05B 2223/06

(57) ABSTRACT

The various embodiments of the present invention provide a system and method for automated dosing of a stocked solution. The embodiments also provide a multipurpose and portable system and method for enabling gravity-based automated volumetric dosing with high accuracy. The nutrient dispensation for agricultural applications is controlled by a plurality of solenoid valves. The volume of solution dispensed is measured by flow sensors. EC & pH readings are monitored continuously from the formulation container. The system maintains the threshold values in the container by dosing the suggested stock solution. The dosing is triggered when the values are outside the preset threshold in formulation container, where the formulation container level is maintained by controlling the water inflow using solenoid valves and level sensors.

### CROSS-REFERENCE TO RELATED APPLICATIONS

This patent application claims the priority of the Indian Provisional Patent Application filed on Aug. 15, 2022, with the number 202241046306 and titled, “SYSTEM AND METHOD FOR AUTOMATED DOSING OF STOCK SOLUTION”, the contents of which are incorporated herein by the way of reference.

### FEDERALLY SPONSORED RESEARCH AND DEVELOPMENT

### Not Applicable.

The present invention is generally related to a system and method for automated dispensing fluids. The present invention is particularly related to a system and method for automated dosing of a stocked solution.

### BACKGROUND OF THE INVENTION

Dispensing of pre-stored materials is one of the key areas of automating vending processes. Especially, dispensing of preset doses of liquids is a key area in many application areas like manufacturing of food, beverages, pharmaceuticals, plastics etc. Also, they also play a vital role in many operational aspects of processes such as nutrients supply or fertigation in agriculture applications, formulation mixing and experimental lab setups in pharma applications, oil dozing in tyres and other engine control applications in automobile applications, to name a few.

Currently used conventional dosing systems work on the principle of pumping, which requires a mechanism for pumping fluid stored in a container. This does not guarantee that an accurate volume of fluid is dispensed as these methods work based on preset duration for which the pumping mechanism is active. Also, since there are moving parts involved in the pumping, the overall maintenance and operation of dosing devices is resource intensive, especially when the dosing process is automated.

Hence, there exists a need for a simplified system and method for automated dosing. There also exists a need for an automated system that enables a gravity-based method for dosing of stock solutions. There further exists a need for a multipurpose and portable system and method for enabling automated volumetric dosing in a plurality of application areas.

The abovementioned shortcomings, disadvantages and problems are addressed herein, which will be understood by reading and studying the following specification.

### SUMMARY OF THE INVENTION

### Object of the Invention

The primary object of the present invention is to provide a system and method for automated dosing of a stocked solution.

Another object of the present invention is to provide an automated system that enables a gravity-based method for dosing of stock solutions.

Yet another object of the present invention is to provide a multipurpose and portable system and method for enabling automated volumetric dosing in a plurality of application areas.

Yet another object of the present invention is to provide a system for enabling automated gravity-based high accuracy method for dosing stock solutions.

Yet another object of the present invention is to provide an automated system and method for dosing stock solutions with minimal moving parts.

These and other objects and advantages of the present invention will become readily apparent from the following detailed description taken in conjunction with the accompanying drawings

The primary object of the present invention is to provide a system and method for automated dosing of a stocked solution.

Another object of the present invention is to provide an automated system that enables a gravity-based method for dosing of stock solutions.

Yet another object of the present invention is to provide a multipurpose and portable system and method for enabling automated volumetric dosing in a plurality of application areas.

Yet another object of the present invention is to provide a system for enabling automated gravity-based high accuracy method for dosing stock solutions.

Yet another object of the present invention is to provide an automated system and method for dosing stock solutions with minimal moving parts.

These and other objects and advantages of the present invention will become readily apparent from the following detailed description taken in conjunction with the accompanying drawings.

### BRIEF DESCRIPTION OF FIGURES AND DRAWINGS

The other objects, features and advantages will occur to those skilled in the art from the following description of the preferred embodiment and the accompanying drawings in which:

FIG. 1 illustrates the front view of a system for gravity-based automated dosing of a stocked solution, according to one embodiment of the present invention.

FIG. 2 illustrates the isometric view of a system for gravity-based automated dosing of a stocked solution, according to one embodiment of the present invention.

FIG. 3 illustrates a sensor chamber for housing a plurality of sensors of a gravity-based automated dosing system, according to one embodiment of the present invention.

FIG. 4 illustrates a method for gravity-based automated dosing of a stocked solution, according to one embodiment of the present invention.

Although the specific features of the present invention are shown in some drawings and not in others. This is done for convenience only as each feature may be combined with any or all of the other features in accordance with the present invention.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments of the present invention provide a system and method for automated dosing of a stocked solution. The embodiments also provide a multipurpose and portable system and method for enabling gravity-based automated volumetric dosing.

According to one embodiment of the present invention, a system for automated dosing of a stocked solution is provided. The system comprises a stock solution container, a plurality of solenoid valves, a display device, a circuit board, a flow sensor module, a plurality of stock solution tubes, a plurality of sensor chamber tubes, an inlet solenoid valve, a water level sensor, a formulation container, a stand, an electrical conductivity sensor, a temperature sensor, a pH sensor and a sensor holding chamber.

According to one embodiment of the present invention, the system for automated dosing of a stocked solution comprises a plurality of stock solution containers.

As used herewith, the terms stock solutions and stocked solutions are used interchangeably herewith. The term stock solution refers to stored or pre-stored stock solution, and is not restricted to any specific chemical composition, or viscosity, pH, or temperature.

According to one embodiment, the solenoid valve (104) is a copper solenoid valve. In one embodiment, the solenoid valve accepts 0-12V DC voltage and doesn't require a pressure drop for operation. In one embodiment, an actuator is directly mounted to the solenoid valve body to minimize movement and reduce wear. According to one embodiment the solenoid valves are pinch solenoid valves.

According to one embodiment the solenoid valves are configured to respond to signals from the electrical conductivity and pH sensors, ensuring precise dosing based on solution properties.

According to one embodiment, the flow sensor (105) is a 5-24V flowmeter 0.3-6 L/min. According to one embodiment, the ¼-inch water flow sensor is a small turbine whose output signal is a series of digital pulses. The frequency of the pulses is proportional to the flow rate of the liquid passing through the sensor. The digital signal with frequency range between 0 Hz and 100 Hz, is read directly through one of the digital input/output pins of a microcontroller.

According to one embodiment, the microcontroller includes a Wi-Fi Module and a Bluetooth module.

According to one embodiment, the lid for the sensor holding chamber ensuring protection and proper positioning of sensors.

According to one embodiment of the present invention, a gravity-based method of automated dosing of stock solution is provided. The method is configured to work without any electromechanical pumps and motors and does not require electricity for its working. The pressure on a plurality of outlets of the dosing system is maintained at same level. The container that houses the gravity-based dosing system is connected to a flow sensor and a solenoid valve, which are designed to work in tandem. When the electrical conductivity value is less than a preset threshold value, the solenoid valves open and allow the solution to flow into the tank. The flow sensor enables measurement of the quantity to be delivered, and the solenoid valves stop the flow of the solution when preset metered quantity of solution is delivered.

According to one embodiment of the present invention, the system for automated dosing of a stocked solution comprises a plurality of sensors including a flow sensor, an electrical conductivity sensor, a pH sensor and a temperature sensor. The flow sensor is configured to measure the quantity of fluid that is delivered by the sensor and is placed in between solenoid valves and stock solutions container. When the preset or measured quantity of solution is delivered, the solenoid valve is set to automatically close and stop the flow of the solution. The electrical conductivity and pH sensors are configured to measure, respectively, the electrical conductivity and pH levels in the solution. They are designed to send signals to a remote microcontroller as an input signal, which triggers the solenoid valves and flow sensor to deliver the required quantity of solution. The temperature sensor is configured to measure the temperature of the solution. The temperature sensor, the electrical conductivity sensor (EC) and the pH sensors are housed in a sensor chamber.

According to one embodiment of the present invention, the method for automated dosing of a stocked solution comprises: measuring readings from a plurality of sensors in the sensor mounting chamber; comparing the measured values with preset threshold values, wherein, when the measured values are equal to the preset threshold values, the system is maintained at a paused state, and wherein when the measured values are different from the preset threshold values, the gravity-based dosing system is activated to deliver preset volume of stocked solution; communicating the actions taken and the information of the dosing operation to a remote cloud server; and, rendering the data on the remote cloud server on a plurality of remote computing devices and digital display devices.

According to one embodiment, the method for automated dosing of a stocked solution comprises the step of dynamically adjusting the preset volume of stocked solution based on real-time data from the electrical conductivity sensor, the temperature sensor, and the pH sensor, ensuring adaptive dosing to account for solution variations, and generating a dosing profile that aligns with the specific requirements of the application.

According to one embodiment, system further comprises a user-friendly interface on the display device, providing real-time dosing progress visualization, detailed solution property trends, and dosing history, enabling operators to make informed decisions, analyze system performance, and optimize dosing strategies based on comprehensive data insights, and allowing the display device to provide remote access for authorized users to monitor and adjust the dosing process remotely.

According to one embodiment of the present invention, the system for automated dosing of a stocked solution has application in the areas of agriculture, pharmaceuticals, fine chemicals, biotechnology, medicine, water treatment, environment protection, food and beverage, ceramics, tyres/automotive. The application in agriculture includes nutrient supply and fertigation. According to one embodiment, the application in pharmaceuticals includes formulation mixing, active ingredients dosing. According to one embodiment the application for automotive includes oil dosing.

### DETAILED DESCRIPTION OF THE FIGURES

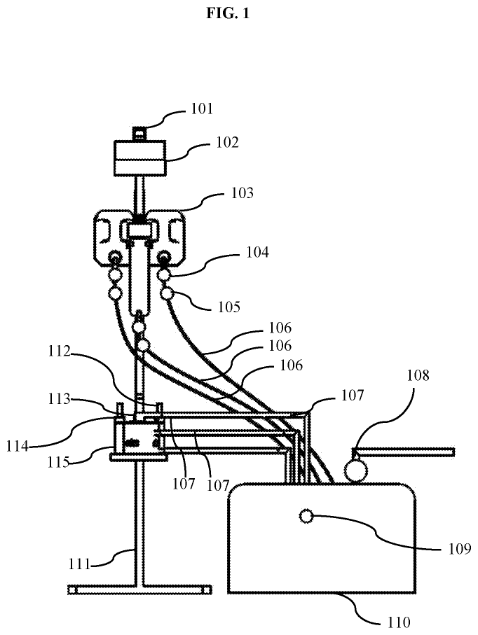

FIG. 1 illustrates the front view of a system for gravity-based automated dosing of a stocked solution. The system comprises a stock solution container 103, a plurality of solenoid valves 104, a display device 101, a circuit board 102, a flow sensor module 105, a plurality of stock solution tubes 106, a plurality of sensor chamber tubes 107, an inlet solenoid valve 108, a water level sensor 109, a formulation container 110, a stand 111, an electrical conductivity sensor 112, a temperature sensor 113, a pH sensor 114 and a sensor holding chamber 115.

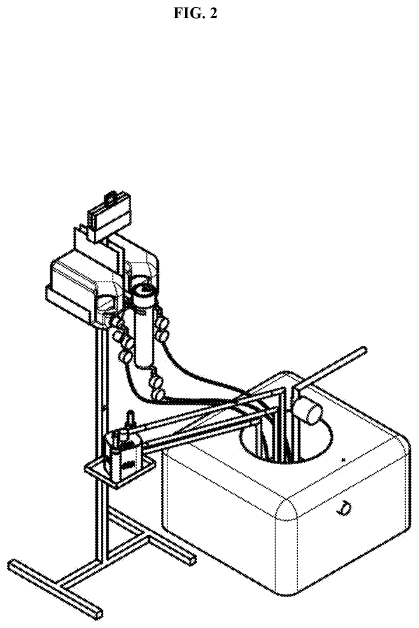

FIG. 2 illustrates the isometric view of a system for gravity-based automated dosing of a stocked solution, according to one embodiment of the present invention.

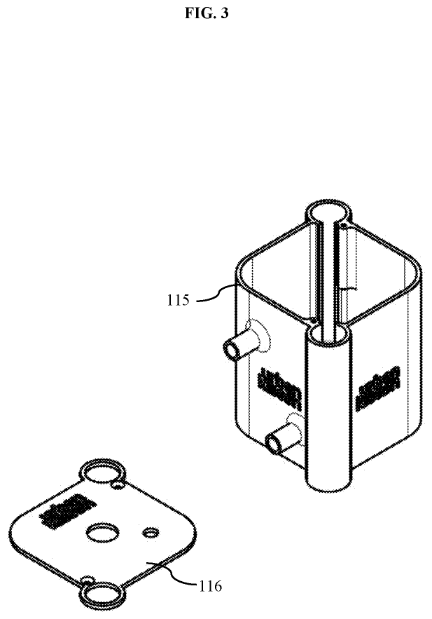

FIG. 3 illustrates a sensor holding chamber 115 for housing a plurality of sensors of a gravity-based automated dosing system, along with the lid of chamber 116.

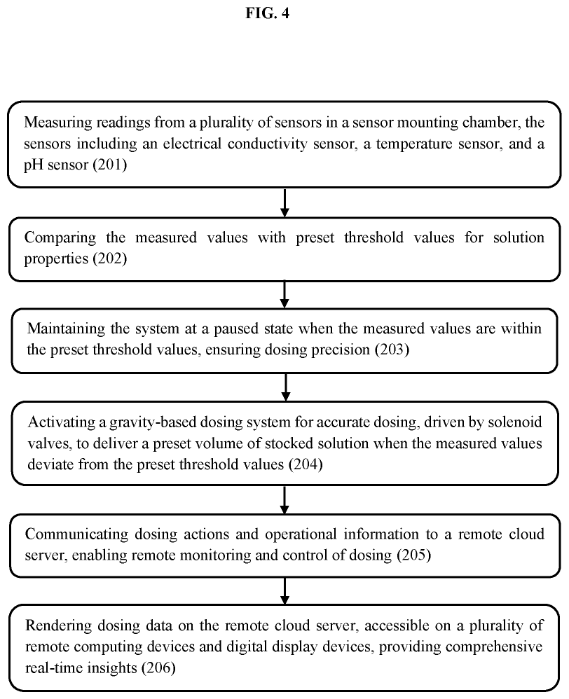

FIG. 4 illustrates a method for gravity-based automated dosing of a stocked solution. The method includes: measuring readings from a plurality of sensors in a sensor mounting chamber, the sensors including an electrical conductivity sensor, a temperature sensor, and a pH sensor; comparing the measured values with preset threshold values for solution properties; maintaining the system at a paused state when the measured values are within the preset threshold values, ensuring dosing precision; activating a gravity-based dosing system, driven by solenoid valves, to deliver a preset volume of stocked solution when the measured values deviate from the preset threshold values, guaranteeing accurate dosing; communicating dosing actions and operational information to a remote cloud server, enabling remote monitoring and control of the dosing process; and, rendering dosing data on the remote cloud server, accessible on a plurality of remote computing devices and digital display devices, providing comprehensive real-time insights.

Although the embodiments herein are described with various specific embodiments, it will be obvious for a person skilled in the art to practice the embodiments herein with modifications.

### Advantages of the Invention

he various embodiments of the present invention provide a system and method for automated dosing of a stocked solution. The embodiments also provide a multipurpose and portable system and method for enabling gravity-based automated volumetric dosing. The present invention doses the stock solutions with preset volumes instead of duration, which helps to achieve accurate dispensation of stock solutions. The volume to dispense is defined as per the requirement. The present invention works based on gravity as against active pumping in the conventional dosing apparatus, and consumes minimal power compared to the traditional dosing devices. The present invention involves less maintenance with long lifetime compared to the traditional devices as it involves minimal moving parts. The present invention is configured to connect with a plurality of computing devices for remote operation and monitoring of the dosing process, including auto-calibration capabilities.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

1. A system for automated dosing of a stocked solution, the system comprising:
a stock solution container for holding a solution to be dispensed;
a plurality of solenoid valves individually operable to control the flow of the solution;
a display device providing real-time information on the dosing process;
a circuit board facilitating automated control of the dosing process;
a flow sensor module for precise measurement of the quantity of solution dispensed;
a plurality of stock solution tubes connecting the stock solution container to the dosing mechanism;
a plurality of sensor chamber tubes for housing sensors;
an inlet solenoid valve regulating the water inflow for maintaining solution levels;
a water level sensor ensuring proper solution levels in the formulation container,
a formulation container for receiving the dosed solution;
a stand providing stability and portability to the system;
an electrical conductivity sensor for monitoring solution properties;
a temperature sensor for maintaining optimal solution conditions;
a pH sensor for accurate solution characterization; and
a sensor holding chamber housing multiple sensors.

2. The system according to claim 1, wherein the system further comprises a remote cloud server enabling real-time data communication with a plurality of remote computing devices and digital display devices, the system transmitting dosing operation data to the remote cloud server.

3. The system according to claim 1, wherein the solenoid valves are configured to respond to signals from the electrical conductivity and pH sensors, ensuring precise dosing based on solution properties.

4. The system according to claim 1, wherein the temperature sensor, the electrical conductivity sensor, and the pH sensors are securely housed in the sensor chamber, providing continuous, accurate readings for maintaining preset threshold values in the formulation container.

5. The system according to claim 1, wherein the system comprises a plurality of stock solution containers.

6. The system according to claim 1, wherein the system further comprises a lid for the sensor holding chamber ensuring protection and proper positioning of sensors.

7. A method for automated dosing of a stocked solution, the method comprising:
measuring readings from a plurality of sensors in a sensor mounting chamber, the sensors including an electrical conductivity sensor, a temperature sensor, and a pH sensor;
comparing the measured values with preset threshold values for solution properties;
maintaining the system at a paused state when the measured values are within the preset threshold values, ensuring dosing precision;
activating a gravity-based dosing system, driven by solenoid valves, to deliver a preset volume of stocked solution when the measured values deviate from the preset threshold values, guaranteeing accurate dosing;
communicating dosing actions and operational information to a remote cloud server, enabling remote monitoring and control of the dosing process; and, rendering dosing data on the remote cloud server, accessible on a plurality of remote computing devices and digital display devices, providing comprehensive real-time insights.

8. The method according to claim 7, wherein the preset volume of stocked solution is dynamically adjusted based on real-time data from the electrical conductivity sensor, the temperature sensor, and the pH sensor, ensuring adaptive dosing to account for solution variations, and generating a dosing profile that aligns with the specific requirements of the application.

9. The method according to claim 7, wherein the system continuously evaluates dosing process parameters and compares them to historical data stored on the remote cloud server, triggering proactive maintenance alerts and predictive maintenance actions, ensuring the system's longevity, reducing downtime, and streamlining maintenance efforts.

10. The method according to claim 7, wherein the system further comprises a user-friendly interface on the display device, providing real-time dosing progress visualization, detailed solution property trends, and dosing history, enabling operators to make informed decisions, analyze system performance, and optimize dosing strategies based on comprehensive data insights, and allowing the display device to provide remote access for authorized users to monitor and adjust the dosing process remotely.

11.

[symbol]

12. [symbol]
